(19) United States
(12) Patent Application Publication
(10) Pub. No.: US 2023/0196836 A1
(43) Pub. Date: Jun. 22, 2023

(54) Human Presence Sensor for Client Devices

(71) Applicant: GOOGLE LLC, Mountain View, CA (US)

(72) Inventors: Megha Malpani, Mountain View, CA (US); Jon Napper, Mountain View, CA (US); Alan Green, Mountain View, CA (US); Aneesha Govil, Mountain View, CA (US); Stuart Langley, Mountain View, CA (US); Ken Hoetmer, Mountain View, CA (US); Christopher Igo, Mountain View, CA (US); Fei Wu, Mountain View, CA (US); Jakub Mlynarczyk, Mountain View, CA (US); Evan Benn, Mountain View, CA (US); Edward O'Callaghan, Mountain View, CA (US); Andrew McRae, Mountain View, CA (US); David Lattimore, Mountain View, CA (US); Dan Callaghan, Mountain View, CA (US); Eddy Chen, Mountain View, CA (US); Boris Lee, Mountain View, CA (US); Tim Callahan, Mountain View, CA (US); Guoxing Zhao, Mountain View, CA (US); Rachael Morgan, Mountain View, CA (US); Michael Martis, Mountain View, CA (US); Sitar Harel, Mountain View, CA (US); Ryosuke Matsumoto, Dublin, CA (US)

(21) Appl. No.: 17/985,275

(22) Filed: Nov. 11, 2022

Related U.S. Application Data
(60) Provisional application No. 63/290,768, filed on Dec. 17, 2021.

(51) Int. Cl. G06V 40/20; G06V 40/16; G06F 3/01; G06T 5/00; G06T 7/20

(52) U.S. Cl. CPC G06V 40/20; G06F 3/011; G06F 3/017; G06T 5/002; G06T 7/20; G06V 40/172; G06T 2207/10016; G06T 2207/30201

(57) ABSTRACT

The technology provides a computing device having a human presence sensor module. An image sensor of the human presence sensor module captures imagery, and the imagery is not disseminated outside of the human presence sensor module to another part of the computing device. One or more machine learning models, each trained to identify whether one or more persons are present in the imagery, are retrieved from memory within the human presence sensor module. The imagery received from the image sensor is processed using the one or more machine learning models to determine whether one or more persons are present in the imagery. Upon detection that one or more persons are present in the imagery, the human presence sensor module issues a signal to an operating system of the computing device so that the computing device can respond to that presence by performing one or more actions.

### CROSS REFERENCE TO RELATED APPLICATIONS

This application claims the benefit of the filing date of U.S. Provisional Pat. Application No. 63/290,768, filed Dec. 17, 2021, the entire disclosure of which is incorporated herein by reference.

### BACKGROUND

People use client computing devices, such as laptops, tablets and netbooks in a variety of settings, including at home, school, their office, coffee shops, airports, etc. In certain locations, a user may want privacy from prying eyes, thus it can be useful to have the screen automatically dim or hide certain private information when others are present. This requires knowing whether a person is in front of their device, whether the person has left their device, and whether another person in the vicinity is looking at the user’s screen. In certain systems, this can involve continuously using the client device’s camera and processing the imagery by the computer’s processing system. However, this can consume significant operating system, memory and other processing resources, which is undesirable especially when the device is not coupled to an external power source. In addition, it may also be undesirable to have the device’s camera continually capturing imagery, as this may raise privacy concerns.

### BRIEF SUMMARY

The technology relates to a human presence sensor for client devices that can eliminate barriers to allowing a user to quickly log onto their device or perform other actions efficiently and effectively while minimizing device resource usage. According to one aspect of the technology, a dedicated, low power, low resolution camera (e.g., a monochrome sensor) provides imagery to a self-contained processing module that processes the imagery using one or more targeted machine learning (ML) models. These models may identify whether a person is within a certain distance of the client device, or whether multiple people are present. The imagery never leaves the self-contained processing module, and the imagery may not be stored once processed using the model(s).

Depending on the output(s) of the model(s), one or more signals may be sent to the operating system or other component of the client device so that various functions can be performed. Thus, the human presence sensor discussed herein has wide applicability in a variety of different situations to enhance the user experience. For instance, in some situations it can be used to speed up the login process, to avoid dimming the screen when the person is reading a long document, to hide certain information when someone else nearby is also looking at the screen, or to lock the device when the user leaves. Knowing that the image is not stored and not accessible to the main processor can provide security and peace of mind to the user. Additionally, knowing how presence information is used (or not used) can provide transparency and a sense of security as well.

According to one aspect, a computing device includes: a processing module including one or more processors; memory configured to store data and instructions associated with an operating system of the computing device; an optional user interface module configured to receive input from a user of the computing device; an optional display module having a display interface, the display module being configured to present information to the user; and a human presence sensor module. The human presence sensor module includes: an image sensor configured to capture imagery within a field of view of the image sensor; local (dedicated) memory configured to store one or more machine learning models, the one or more machine learning models each being trained to identify whether one or more persons are present in the imagery; and local processing such as a dedicated processing module including at least one processing device configured to process the imagery received from the image sensor using the one or more machine learning models to determine whether one or more persons are present in the imagery. Imagery captured by the image sensor of the human presence sensor module is not disseminated outside of the human presence sensor module. Thus, such captured imagery is restricted to the human presence sensor module. In response to detection that one or more persons are present in the imagery, the human presence sensor module is configured to issue a signal to the processing module of the computing device, such that the processing module responds to the signal by executing one or more instructions associated with the operating system of the computing device.

In one example, the human presence sensor module further includes a module controller operatively coupled to the image sensor, the dedicated memory and the dedicated processing module. Here, the module controller is configured to receive a notification from the dedicated processing module about the presence of the one or more persons in the imagery, and to issue the signal to the processing module of the computing device. The image sensor may be further configured to: detect motion between sequential images; and to issue a wake on approach signal to the module controller in order to enable the module controller to cause one or more components of the human presence sensor module to wake up from a low power mode. Alternatively or additionally, the image sensor is further configured to detect motion between sequential images, and the dedicated processing module is configured to start processing the imagery in response to the detection of motion.

The one or more machine learning models may comprise a first machine learning model trained to detect the presence of a single person in the imagery, and a second machine learning model trained to detect the presence of at least two people in the imagery. The machine learning models may further include a model to detect at least a portion of a human face, a model to detect a human torso, a model to detect a human arm, or a model to detect a human hand.

In one example, the signal to the processing module of the computing device is an interrupt, and the interrupt causes a process of the computing device to wake the computing device from a suspend mode or a standby mode. In another example, the signal to the processing module of the computing device is an interrupt, and the interrupt causes a process of the computing device to initiate face authentication using imagery other than the imagery obtained by the image sensor of the human presence sensor module. In yet another example, the computing device further comprises a display module having a display interface, the display module being communicatively coupled to the processing module and being configured to present information to the user. Here, the signal to the processing module of the computing device is an interrupt, and the interrupt causes a process of the computing device to display information on the display module.

According to another aspect, a computer-implemented method for a computing device having a human presence sensor module is provided. The method comprises: capturing, by an image sensor of the human presence sensor module, imagery within a field of view of the image sensor, wherein the imagery captured by the image sensor of the human presence sensor module is restricted to the human presence sensor module (and thus not disseminated to another part of the computing device); retrieving from memory of the human presence sensor module, by at least one processing device of the human presence sensor module, one or more machine learning models, the one or more machine learning models each being trained to identify whether one or more persons are present in the imagery; processing by the at least one processing device of the human presence sensor module, the imagery received from the image sensor using the one or more machine learning models to determine whether one or more persons are present in the imagery; and upon detection that one or more persons are present in the imagery, the human presence sensor module issuing a signal to a processing module of the computing device so that the computing device can respond to that presence by performing one or more actions.

The method may further comprise, in response to detection of the presence of the one or more persons, causing the computing device to wake on arrival of a person within the field of view of the image sensor. Alternatively or additionally, the method may further comprise, in response to detection of a person leaving the field of view of the image sensor, causing the computing device to lock so that authentication is required to access one or more programs of the computing device. Alternatively or additionally, the method may further comprise, in response to detection of a person leaving the field of view of the image sensor, at least one of muting a microphone of the computing device or turning off a camera of the computing device, wherein the camera is not the image sensor of the human presence sensor module.

The method may further comprise, in response to detection of the presence of at least two persons in the imagery, performing at least one of issuing a notification to a user of the computing device or blocking one or more notifications from being presented to the user. Alternatively or additionally, in response to detection of the presence of at least two persons in the imagery, the method may further include enabling a privacy filter on a display of the computing device.

The method may further comprise, in response to detection of the presence of one person in the imagery, performing gesture detection based on additional imagery captured by the image sensor of the human presence sensor module. Alternatively or additionally, in response to detection of the presence of one person in the imagery, the method may further include performing gaze tracking based on additional imagery captured by the image sensor of the human presence sensor module. Alternatively or additionally,, in response to detection of the presence of one person in the imagery, the method may further include performing dynamic beamforming to cancel background noise based on additional imagery captured by the image sensor of the human presence sensor module.

For any example above, the method may further comprise detecting, by the image sensor, motion between sequential images of the captured imagery, and causing one or more components of the human presence sensor module to wake up from a low power mode in response to detecting the motion. Alternatively or additionally, when the signal to the processing module of the computing device is an interrupt, the interrupt may cause a process of the computing device to initiate face authentication using imagery other than the imagery obtained by the image sensor of the human presence sensor module.

### BRIEF DESCRIPTION OF THE DRAWINGS

FIGS. 1A-D illustrates examples involving human presence sensing in accordance with aspects of the technology.

FIG. 2 illustrates a block diagram of an example client device in accordance with aspects of the technology.

FIG. 3 illustrates a functional diagram of an example client device in accordance with aspects of the technology.

FIG. 4 illustrates an example scenario image evaluation by a human presence sensor module in accordance with aspects of the technology.

FIGS. 5A-B illustrate an example scenario in accordance with aspects of the technology.

FIGS. 6A-B illustrate an example scenario in accordance with aspects of the technology, and FIG. 6C illustrates a workflow in accordance with this scenario.

FIGS. 7A-B illustrate an example scenario in accordance with aspects of the technology.

FIGS. 8A-B illustrate an example scenario in accordance with aspects of the technology.

FIGS. 9A-B illustrate an example scenario in accordance with aspects of the technology.

FIGS. 10A-B illustrate an example scenario in accordance with aspects of the technology.

FIGS. 11A-B illustrate an example scenario in accordance with aspects of the technology.

FIG. 12 illustrates an example scenario in accordance with aspects of the technology.

FIG. 13 illustrates an example user notification in accordance with aspects of the technology.

FIGS. 14A-B illustrate a system for use with aspects of the technology.

FIG. 15 illustrates a method in accordance with aspects of the technology.

### DETAILED DESCRIPTION

### Overview

According to the technology, a self-contained human presence processing module is able to efficiently detect whether a person is at or near a given client device. This is done using a minimum amount of resources that are segregated from the rest of the processing system of the client device. This allows imagery captured by a dedicated sensor to be evaluated by one or more ML models so that the human presence sensor can signal to the operating system or other part of the client device whether one or more actions are to be performed. Imagery captured by the dedicated sensor need not be saved locally by the processing module, and such imagery is not transmitted from the processing module to another part of the client device. This promotes security and privacy while enabling a rich suite of UX features to be provided by the client device, using a minimum amount of system resources.

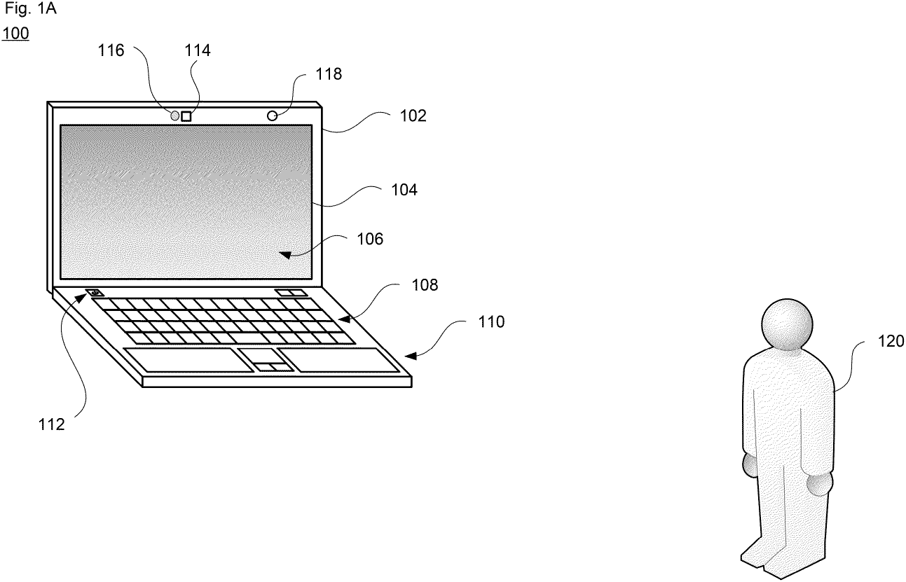

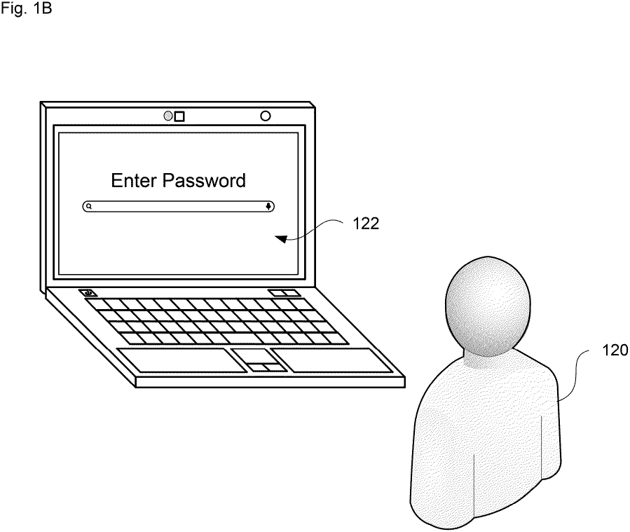

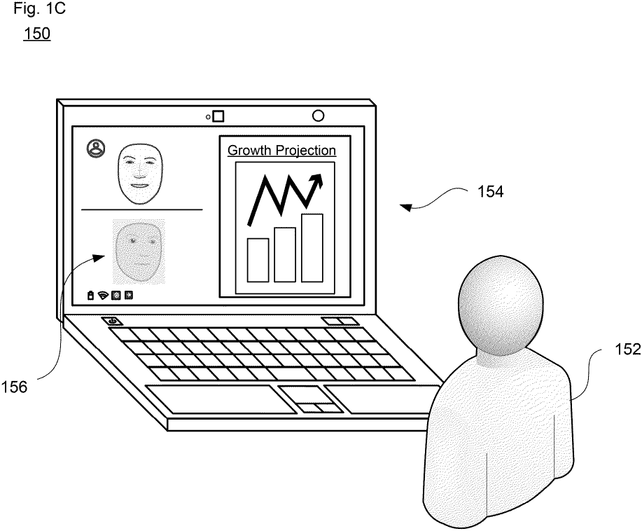

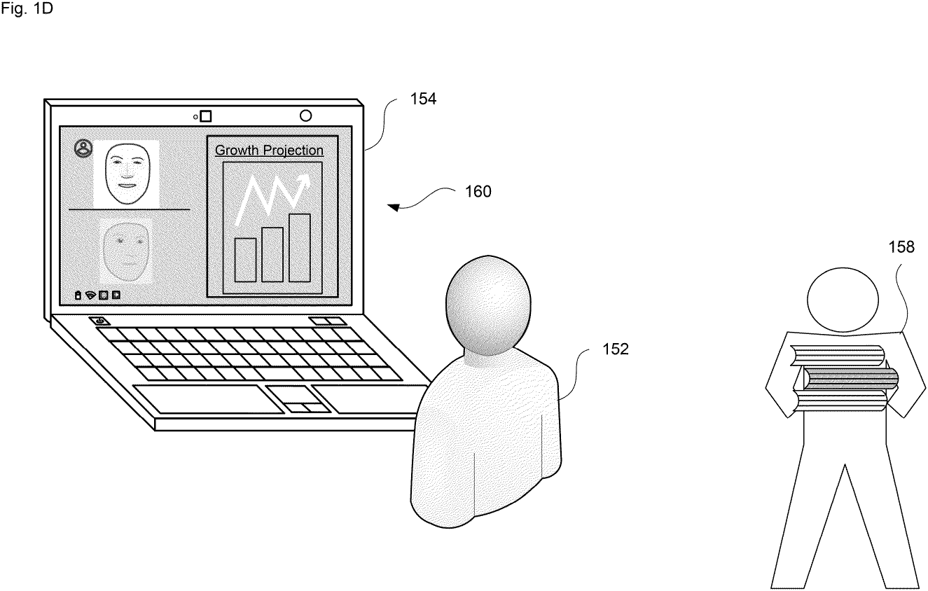

FIG. 1A illustrates an example 100 showing a client device 102, such as a laptop computer. In this example, display 104 is displaying a screen saver 106 because the client device is not actively being used. As shown, the client device includes a keyboard 108, one or more trackpads or mousepads 110, and a microphone 112 as different user inputs. An integrated webcam 114 can be used for videoconferences, interactive gaming, etc. Indicator 116, such as an LED, may be illuminated to alert a user whenever the integrated webcam is in use. The client device also includes a camera or other imaging device 118 that is part of a human presence sensor. As shown, the imaging device 118 may be positioned along a top bezel of the client device. In some examples the imaging device may be located in a different position along the client device. For instance, if it is a tablet or other device that is intended to be rotated in different orientations during use, then the imaging device may be positioned along a side of the housing. Here, there may be no indicator associated with the imaging device 118.

In this example, assume a person 120 enters the room. When the person comes within detection range of the imaging device 118, e.g., within the device’s field of view and within 2-5 meters of the client device or otherwise when the person comes into view, the human presence sensor evaluates one or more images obtained by the imaging device according to one or more ML models implemented by a processing module of the human presence sensor. Then, as shown in FIG. 1B, upon determination that a person is present, the human presence sensor sends a signal to the operating system of the client device, causing a change from the screen saver to a login screen 122.

FIG. 1C illustrates another example 150 in which a person 152 is logged in and using the client device. Here, the person 152 may be using a videoconference program 154 to interact with one or more other people, for instance to discuss a growth projection on a spreadsheet as shown on the display. Here, the integrated webcam is used to capture video or still imagery for display in the program as shown at 156. However, what is displayed on the screen may be sensitive or personal (e.g., a growth projection of someone’s investment portfolio). Thus, as shown in FIG. 1D, when another person 158 is identified by the human presence sensor as being nearby (and possibly looking toward the screen), the human presence sensor sends a notification to the operating system, the videoconference program or another part of the client device. By way of example, in response to the notification, the operating system or the program may cause the display screen to dim as shown at 160. In some situations, specific information being displayed, such as the spreadsheet, notifications, icons or other objects, may be hidden upon the notification about the other nearby person. Alternatively and/or additionally, the system may give an indication to the user (for example showing an alert in a UI window) that someone is watching. In this way, the human presence sensor can help provide a feeling of security to the user regarding content that was being displayed.

### System Architecture

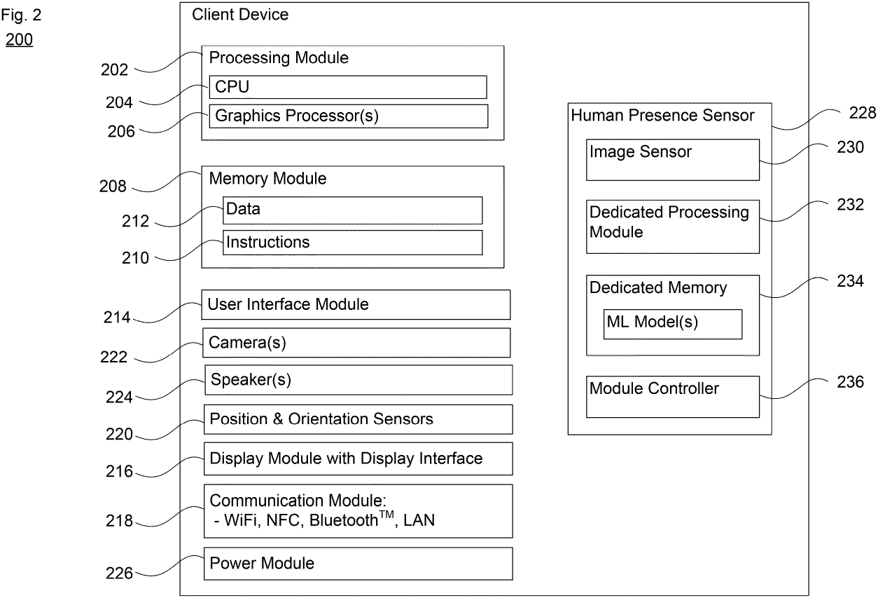

FIG. 2 illustrates a block diagram of an example client device 200, such as a laptop computer, tablet PC, netbook, an in-home device such as a smart display, or the like. As shown, the client device includes a processing module 202 having one or more computer processors such as a central processing unit 204 and/or graphics processors 206, as well as memory module 208 configured to store instructions 210 and data 212. The processors may or may not operate in parallel, and may include ASICs, controllers and other types of hardware circuitry. The processors are configured to receive information from a user through user interface module 214, and to present information to the user on one or more display devices of the display module 216 having a display interface.

User interface module 214 may receive commands from a user via user inputs and convert them for submission to a given processor. The user interface module may link to a web browser (not shown). The user inputs may include one or more of a touch screen, keypad, mousepad and/or touchpad, stylus, microphone, or other types of input devices. The display module 216 may comprise appropriate circuitry for driving the display device to present graphical and other information to the user. By way of example, the graphical information may be generated by the graphics processor(s) 206, while CPU 204 manages overall operation of the client device 200. The graphical information may display responses to user queries on the display module 216. For instance, the processing module may run a browser application or other service using instructions and data stored in memory module 208, and present information associated with the browser application or other service to the user via the display module 216. The memory module may include a database or other storage for browser information, location information, etc.

Memory module 208 can be implemented as one or more of a computer-readable medium or media, a volatile memory unit or units, or a non-volatile memory unit or units. The memory module 208 may include, for example, flash memory and/or NVRAM, and may be embodied as a hard-drive or memory card. Alternatively, the memory module 208 may also include removable media (e.g., DVD, CD-ROM or USB thumb drive). One or more regions of the memory module 208 may be write-capable while other regions may comprise read-only (or otherwise write-protected) memories. In one implementation, a computer program product is tangibly embodied in an information carrier. Although FIG. 2 functionally illustrates the processor(s), memory module, and other elements of client device 200 as being within the same overall block, such components may or may not be stored within the same physical housing. For example, some or all of the instructions and data may be stored on an information carrier that is a removable storage medium (e.g., optical drive, high-density tape drive or USB drive) and others stored within a read-only computer chip.

The data 212 may be retrieved, stored or modified by the processors in accordance with the instructions 210. For instance, the data may be stored in computing device registers, in a relational database as a table having a plurality of different fields and records, XML documents or flat files. The data may also be formatted in any computing device-readable format.

The instructions 210 may be any set of instructions to be executed directly (such as machine code) or indirectly (such as scripts) by the processor(s). For example, the instructions may be stored as computing device code on the computing device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in FIG. 2, the client device 200 includes a communication module 218 for communicating with other devices and systems, including other client devices, servers and databases. The communication module 218 includes a wireless transceiver; alternatively, the module may alternatively or additionally include a wired transceiver. The client device 200 may communicate with other remote devices via the communication module 218 using various configurations and protocols, including short range communication protocols such as near-field communication (NFC), Bluetooth™, Bluetooth™ Low Energy (BLE) or other ad-hoc networks, the Internet, intranets, virtual private networks, wide area networks, local networks, private networks using communication protocols proprietary to one or more companies, Ethernet, WiFi and HTTP, and combinations of the foregoing.

In addition, the example client device 200 as shown includes one or more position and orientation sensors 220. The position and orientation sensors 220 are configured to determine the position and orientation of one or more parts of the client computing device 200. For example, these components may include a GPS receiver to determine the device’s latitude, longitude and/or altitude as well as an accelerometer, gyroscope or another direction/speed detection device such as an inertial measurement unit (IMU). The client device 200 may also include one or more camera(s) 222 for capturing still images and recording video streams such as the integrated webcam as discussed above, speaker(s) 224 and a power module 226. Actuators to provide tactile feedback or other information to the user, as well as a security chip such as to prevent tampering with bios or other firmware updates (not shown) may also be incorporated into the client device 200.

In addition to these components, the client device also includes a human presence sensor module 228. As shown, this module includes an image sensor 230, local processing such as a dedicated processing module 232, dedicated (local) memory 234, and a module controller 236. In one example, the image sensor is a dedicated low power, low resolution camera, which may provide greyscale or color (e.g., RGB) imagery that has a size (in pixels) of 320 x 240, 300 x 300 or similar size (e.g., +/- 20%). During operation, imagery may be taken once every 2-10 seconds (or more or less). The dedicated processing module of the local processing may comprise an FPGA or other processing device capable of processing imagery received from the image sensor in real time using one or more ML models. The models themselves are stored in the dedicated local memory. This memory may be flash memory (e.g., SPI flash memory configured for efficiency with the FPGA). In one example, the flash memory may have several megabytes of storage for the models and no more than 1 MB of onboard RAM for performing image processing using the model(s). Thus, the imagery may be restricted to the dedicate memory during processing, without dissemination to other parts of the client device.

The human presence sensor module 228 is configured to operate using as little power as possible, for instance on the order of 100 mW or less. Power usage can be minimized in several ways, including putting the local memory into a low power mode whenever possible. Being able to more quickly and accurately dim the screen using the approaches discussed herein can save additional power. In one scenario, the module 228 may use 5-10 mW in a “Wake on Approach” mode (such as in the example of FIGS. 1A-B). This may be achieved by turning off the local processing while its usage is not required. Here, by way of example, the module 228 may either rely on movement detection incorporated into the image sensor to wake up the local processing or by starting the local processing approximately once every 1-15 seconds to check whether it is needed.

In these embodiments, imagery obtained by the image sensor is not stored in the local memory after processing. Regardless of whether any imagery is maintained by the human presence sensor module, it is not transmitted to another part of the client device and would not be used as imagery for a webcam. The module controller may be, for example, a microcontroller or other processing unit configured to manage operation of the human presence sensor and to interface with the processing module 202 or other part of the client device external to the human presence sensor.

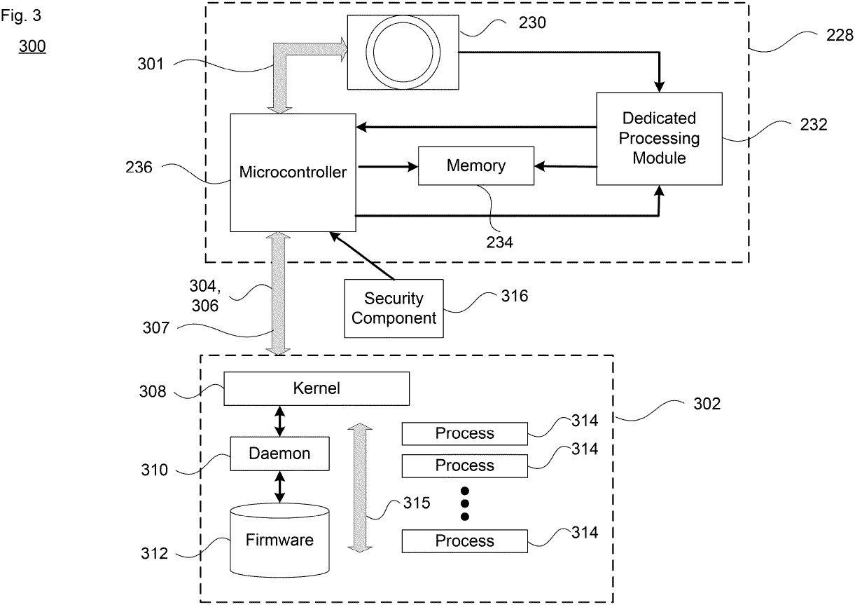

FIG. 3 illustrates an example 300 of the logical architecture of the client device 200 with the human presence sensor module 228.

As shown, the module controller 236 is operatively connected to the image sensor 230, local processing by dedicated processing module 232 and dedicated (local) memory 234. The module controller is able to turn the dedicated processing module (local processing) and the local memory on and off, and can update the local memory as needed, such as to add new ML models or update existing models. In these embodiments, the module controller couples to the image sensor via an I2C interface 301, while it couples to the local processing (and/or local memory) via an SPI interface. In these embodiments, the module controller may be responsible for ensuring only trusted code runs on the human presence sensor module while the client device is in secure mode, for instance by writing the contents of the memory and verifying it. The module controller may also be responsible for managing power states and communicating configuration and status from and to the client device operating system. The module controller may employ a daemon that is responsible for booting the human presence sensor module into a known-good state each time it is powered on. Once it is booted, the daemon can configure functions of the local processing (e.g., person detection, second person detection, etc.).

The image sensor is configured to output imagery to the local processing and may send motion detection information, but not imagery, to the module controller. For instance, the module may default to a very low power state in which it is just looking for motion. When motion is detected by the image sensor, the other components can power up to determine if there is a person in view. If so, the local processing will start doing human presence detection to see if the device should be woken up fully. If not, then the system can go back to low power motion sensing. The local processing may temporarily store data in the local memory when running the one or more ML models on the received imagery. The models may be configured as, e.g., compact models configured for use with microcontrollers having limited memory (e.g., on the order of hundreds of kilobytes of memory or less with which to run the models). Once processed, the local processing is configured to send commands and/or data to the module controller. By way of example, commands sent to the microcontroller can include: (1) Human Detected; (2) No Human Detected; or (3) Second (or additional) Person Detected, etc. These commands can be forwarded to the operating system of the computing device with minimal additional processing.

As shown, the module controller is operatively coupled to an operating system 302 of the client device. For instance, this may be done using an I2C or SPI bus interface, which may pass through a hinge of the client device (such as on a laptop computer). Via this interface, the module controller can issue interrupts 304 or send commands, results or other signals 306 via a bus 307, which may be used by the operating system, a specific app or program (e.g., a login app or a videoconference program) or other part of the client device to take some action upon determination that there are one or more people in view of the imaging device of the human presence sensor. By way of example, interrupts can indicate that a person is present or some other condition in the environment detectable by the human presence sensor module. An interrupt can be used to wake the computing device from a suspend or standby mode, e.g., to initiate face authentication or to display information such as notifications or weather. Thus, one general mode of operation is for the human presence sensor module to send the results of inferences of one or more models executed by the local processing to the operating system, and to allow one or more processes of the operating system to interpret those results and respond or otherwise proceed accordingly.

The operating system may logically include, as shown, a kernel 308, a human presence sensor daemon 310, firmware 312 and one or more routines or other processes 314 such as to control power to the display device or other devices. The human presence sensor daemon 310 is a software daemon responsible for coordinating communication between the human presence sensor module 228 with the processes 314. The kernel may communicate with the routines or other processes via a system bus 315, such as a d-bus, for inter-process communication. Shown separately from the operating system and the human presence sensor module is a security component 316, such as a security chip. In one example, the security chip provides firmware write protection to both the operating system and the human presence sensor module, and provides updated and correct firmware for the microcontroller 236 and dedicated processing module 232. The security component 316 may communicate with the human presence sensor module via the bus 307 or other link.

### Presence Models

According to an aspect of the technology, as noted above the local processing may employ one or more ML models, which are stored in the local memory. By way of example, the models may include a first model for detecting whether any person is present, and a second model for detecting whether there are any other people in the vicinity as this may indicate the need for the operating system or a specific program running on the client device to take a privacy-related action. As discussed further below and as shown in the example of FIGS. 1A-B, if one person is detected via the first model when the client device is a sleep mode or other low power state, the presence detection can trigger the system to present a password or other login screen in a “wake on approach” mode. Or, if the first model does not detect any person being present, this may either trigger the system to dim the display screen(s) to save power and/or to lock access to the client device. In a situation where the second model detects the presence of other people in addition to a user (e.g., people in the background such as “shoulder surfers”), this may trigger the system to take an action such as to dim the screen or to blur, deemphasize or otherwise hide selected content from being presented on the screen (e.g., potentially sensitive information, status notifications about email or other messages, etc.). In other situations, there may be another person that is interacting with the user, such as collaborating on a spreadsheet or sitting in on a videoconference. In these types of situations, dimming the screen or similar actions may not be suitable, although the system may pause or limit the display of personal notifications to the user when the other (authorized) person is present.

The models implemented in the human presence sensor module are configured to detect human faces or other parts of a person in images. For example, the head might be mostly above the screen, but the person’s torso, arm or other portion of their body might be visible. Thus, while a cat or other pet may approach the client device, the models are designed so that the system does not react to that presence (e.g., a pet lock mode). Because one aspect involves a self-contained presence detection system effectively walled off from other parts of the client device (without sending the obtained imagery to those other parts) and another aspect is a goal to keep power usage as low as possible, the image processing is bound by tight constraints. This can include limited memory for storage (e.g., ROM) and usage of the models (e.g., buffers or RAM), as well as restrictions on processing throughput. The models may also factor in one or more of the following: user position with respect to the camera, facial hair and/or different hair styles, facial expressions, whether glasses or accessories are being worn (e.g., earbuds or headphones), variations in lighting, variations in backdrop (e.g., office or classroom setting, indoors versus outdoors, etc.).

In view of this, the following are some constraints that may be placed on the model(s). In one scenario, the model(s) needs to detect when there is a person using the device with another person potentially looking at their screen. Thus, there can be considered two cases: (i) zero or one person in the image, and (ii) two or more people in the image. As indicated above, these cases may be addressed by separate models, although alternatively a single model may be employed. For instance, a model that detects or counts the number of faces in an image would be suitable.

In one scenario, the model must reliably detect faces up to about 2-3 meters away from the camera with approximately a 10-pixel face width. In this scenario, the model(s) would also meet the following requirements. First, be able to work on grayscale (or color) images having an aspect ratio such as 320×240 or 300×300. The model size may be constrained to be less than 1 MB. Each model may employ, by way of example, a convolutional neural network (CNN), recurrent neural network (RNN), long short-term memory (LSTM) network or combination thereof. In one scenario, the model may be formatted in order to run compactly on a microcontroller with limited memory (e.g., on the order of a few hundred kilobytes). The model plus any post-processing may be required to run at > 5 Hz.

ML models are able to reduce a large amount of data (e.g., brightness values of thousands of pixels) into a small amount of information (e.g., a probability that the picture contains a cat or a person). Broadly speaking, such models perform a sequence of operations that produce more and more compact representations of the information contained in the data. However, during the first few layers of a CNN or other model, they often expand the number of dimensions, making the data less compact and hence use more RAM before reducing them again.

By way of example only, a sequence of operations may convert an input 160×160 RGB image represented as 76,800 8-bit integer values to a 40×40×8 tensor represented as 12,800 8-bit integers. In doing so, the process would expand and reduce the number of channels (“depth”) image twice, (i) first by expanding the image from 3 channels to 16, then reducing it to 8 channels, then (ii) next by expanding the 8 channels to 48, before reducing it to 8 again. Such operations may require a significant amount of memory (e.g., over 350 KB) because they each convert between 80×80×8 and 80×80×48 activation buffers. Thus, it is desirable in a constrained system such as the human presence sensor herein to modify the processing so that certain operations use less memory. This may be done by refactoring those operations into multiple sub-operations, which each work on a portion (aka a “tile”) of the buffer. The input data can be split into tiles by rows of input. Such an approach may reduce the memory requirement to below 250 KB.

The human presence sensor module may be configured to check for presence when the computing device is in a certain configuration or orientation. For instance, this may occur when the device lid for a laptop is open in a clamshell mode, or when a convertible device is in “tent” mode. In contrast, when the lid is closed or the device is in tablet mode, the system may not check for presence.

Generating suitable models that can be processed in a memory-constrained manner can be accomplished in different ways. For instance, one could train models with a tiled architecture, ensuring weights are shared appropriately. Or, existing trained models could be post-processed to tile them accordingly. In addition, during training, the system may perform a dropout process in which some selected percentage (e.g., 5% - 50%) of output nodes in a layer (of the CNN, for instance) are randomly ignored, as this can help prevent overtraining of the model and can improve generalization to different types of human faces. Different data sets may be used to train the model(s). By way of example only, the models may be trained as discussed in “Visual Wake Words Dataset” by Chowdhery et al., published Jun. 12, 2019, which is incorporated herein by reference in its entirety.

In one scenario, the model training may include one or more types of image augmentation to help generate robust models. This can include scaling face size (e.g., to help identify children and adults or identify whether someone is near or far), translate faces, clip faces, synthesize multi-face images, and/or blur out selected face details. In a baseline set of imagery, before training any images without faces can be discarded. Then according to one example, do one or both of the following: (i) select the largest face in the image set and scale it such that the height of the face is up to 110% of the image height, and (ii) move the face to a random location in the image. In this case, at least 60-80% of the image should be visible on screen (not clipped at the edges). If padding is required for the image due to the translation, one can either repeat the last row / column, or reflect the image to fill (being careful not to remove/reflect other faces). The training may also involve adding a “synthetic” second person. Here, two images containing faces are chosen. One of the faces is then smoothly blended into the other image. This could incorporate a region that includes part of the body as well. The blend should look as realistic as possible so the ML model cannot learn that images with blended faces are always a second person. Faces may also be blended into images without any faces in them to help with this as well.

The following are examples for two models: a first model (e.g., a “Presence0” model) that detects if a person is in the image, and a second model (e.g., a “Second0” model) that detects if 2 or more people are in the image. The Presence0 model may be configured as a binary classifier that outputs a value in [0, 1], where values close to 1 indicate high likelihood of a person in the image. A threshold (ti) is chosen, in which any value >= ti is classified as having a person in the image. The Second0 model may be configured as a binary classifier that outputs a value in [0, 1], where values close to 1 indicates high likelihood of 2 or more people in the image. Similar to the above, a threshold (t₂) is chosen in which any value >= t₂ is classified as having two or more people in the image. In one example, ti = t₂. In another example, t₁ and t₂ may differ. The input imagery from the image sensor may be 320 x 240 grayscale images or other greyscale images of similar size (e.g., 300 × 300). As noted above, color images may also be obtained from the image sensor.

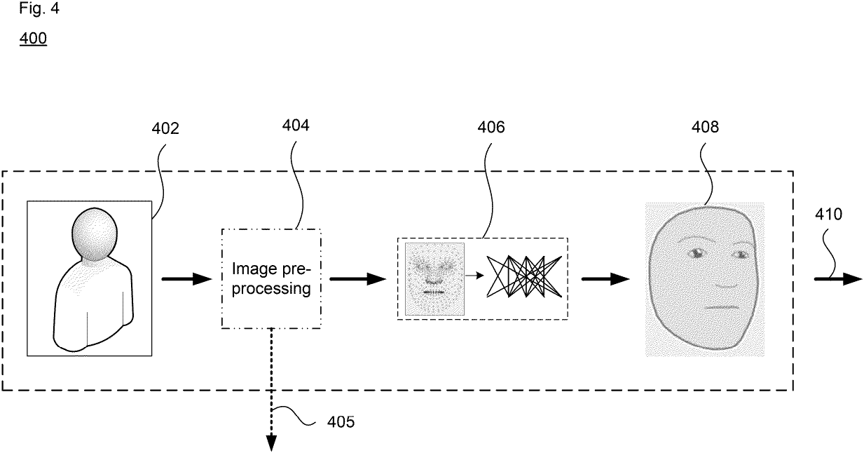

FIG. 4 illustrates an example scenario 400 for image evaluation by the human presence sensor module in view of the above. At block 402 the image sensor captures an image, which may be a greyscale image. The image may be on the size of, e.g., 320 × 240 or 300 × 300, or a similar size of moderate or low resolution. Next, at block 404 one or more pre-processing operations may be performed by the image sensor or by the local processing. For instance, the image sensor or local processing may make adjustments to the image exposure, gain (analog and/or digital gain) or other image parameters, crop the image, convert from a color (e.g., RGB) image to a greyscale image if the image sensor generates color imagery (e.g., an image sensor having a Bayer filter), etc. Preprocessing may additionally or alternatively include detecting when images are unusable (e.g., all black or fully saturated).

Image pre-processing can additionally or alternatively include the image sensor extracting motion information from the image, e.g., based on a comparison of the image pixels to those of one or more images taken immediately prior to the current image. Here, the extracted motion information would be sent to the module controller as indicated by the dotted downward arrow 405 from the image pre-processing block 404. Note that image sensor parameters, such as to account for different lighting conditions, may be calibrated at initial setup (e.g., each time the human presence sensor module is turned on or each time the image sensor is initialized), and may also be adjusted in between image captures. For instance, during a first image capture there may be no one in the room and the lights are off. However, when a person enters the room and turns on the lights, this could necessitate adjustment to the exposure or other parameters. The image capturing process itself may occur continuously every X milliseconds, such as every 100-500 milliseconds (or more or less), so long as the human presence sensor module is operating. Here, operation of the module may involve the user of the client device affirmatively granting permission.

At block 406 the local processing applies the one or more ML models to the raw or pre-processed image. The models are maintained in local memory and during processing data is temporarily stored in, e.g., RAM, of the local memory, thereby ensuring that all processing of the imagery is segregated from the other components of the client device. In addition to detecting the presence (or absence) of one or more people in an image, there may be one or more models configured to detect human faces or other parts of a person such as a torso, arm, hand, leg etc. Another model may be trained to detect people wearing masks, or who’s faces are otherwise partly obscured (such as when a person is not directly facing the image sensor. In one scenario, at least 30% of the face may need to be visible at the edge of the image to detect the presence of a person. As shown by block 408, output from the applied models may be an indication that one or more people are present. And as shown by arrow 410, an interrupt, commands, result or other signal may be issued by the local processing and/or the module controller so that the operating system or other part of the client device may perform one or more actions in response to the presence detection.

### Example Scenarios and Applications

The human presence detection information generated by the firewalled module can be used in a wide variety of applications and scenarios, as discussed in detail below.

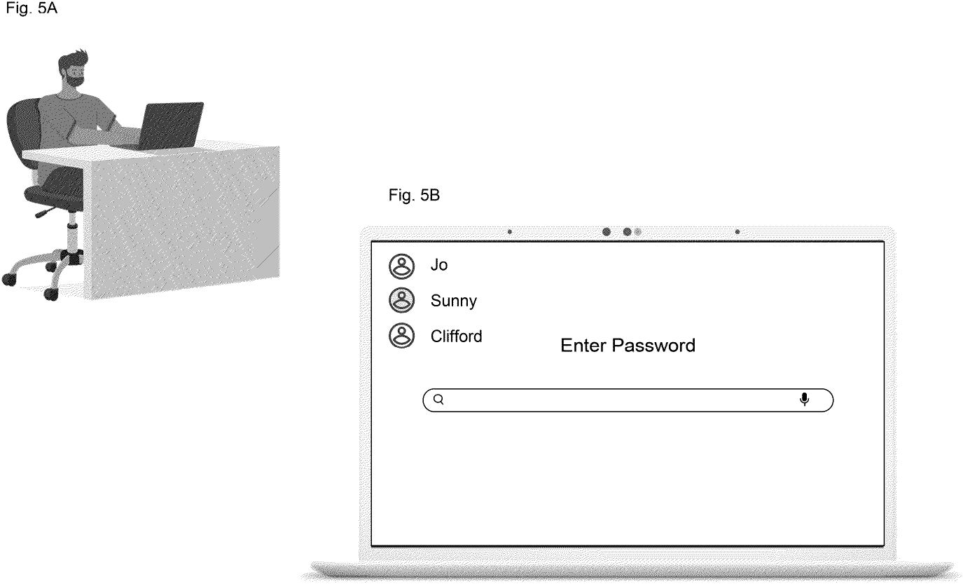

One scenario, illustrated in FIGS. 1A-B, involves “wake on arrival”, where the client device wakes up and displays a password or other lock screen when user presence is detected. Here, the human presence sensor module (e.g., 228 in FIG. 2) would constantly be running when the client device is asleep. In one example, as shown in FIG. 5A, the user sits down at their client device (e.g., a laptop) to start work for the day. The human presence sensor module detects the arrival of the user and automatically wakes up the client device and causes a lock screen to be displayed for the user to sign in without the need for the person to touch the client device, as shown in FIG. 5B.

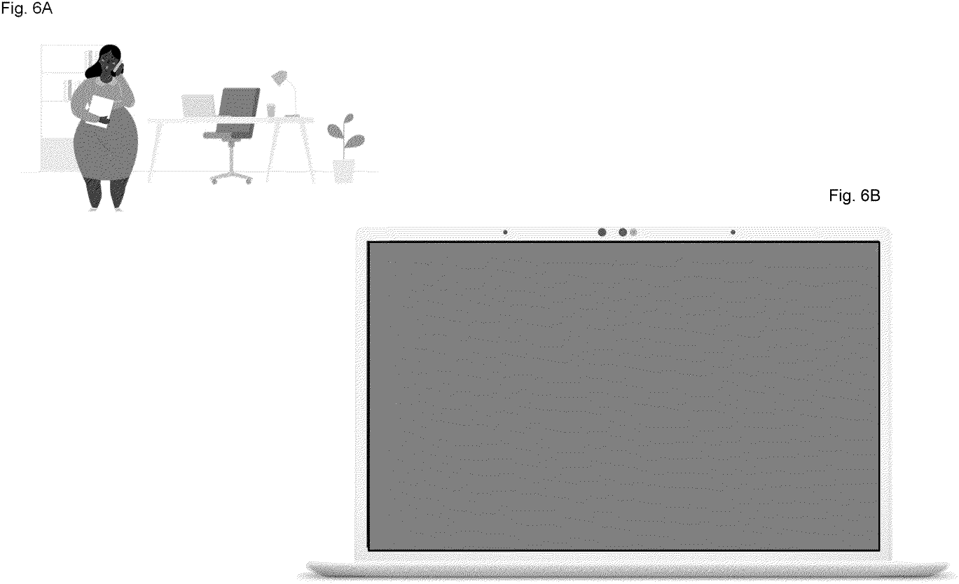

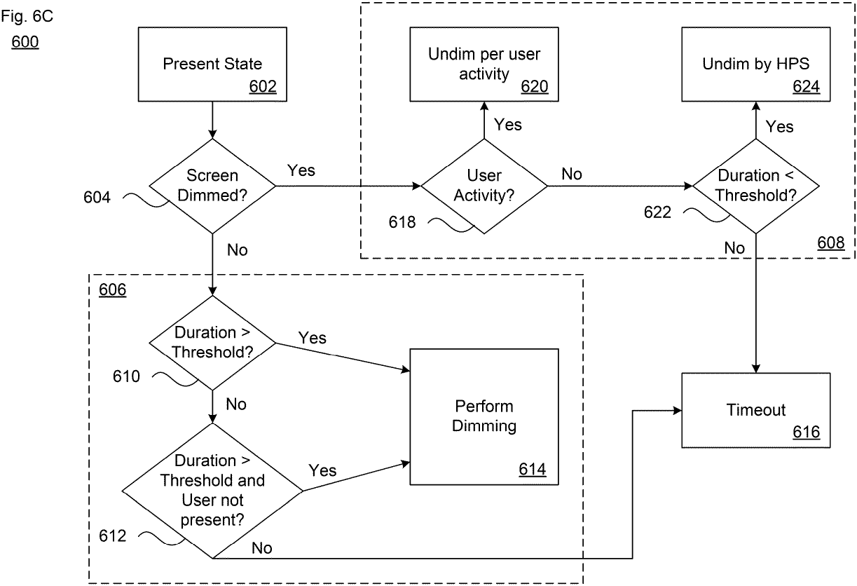

Another scenario involves “lock on leave”, which involves locking the client device when human presence is no longer detected. For instance, as shown in FIG. 6A, the user may step away from their client device to take a call. In response to the lack of detection of their presence, the system causes the client device to lock for security and can dim or turn off the screen to conserve power as shown in FIG. 6B (or display a screen saver). How long the system waits to lock the computer and dim/turn off the display may vary, for instance based on system power saving settings and/or user preferences. By way of example, the screen may dim immediately after no presence is detected or some limited time (e.g., 1-30 seconds, or longer). Here, the computer may then lock after dimming or some other amount of time (e.g., after 1-5 minutes, or more or less). Upon lockout the screen may turn off (or display a screen saver).

In some instances, there is a possibility that the presence detection could incorrectly identify the presence of a person, or that the person is not present. Should the latter situation occur, the system may incorrectly dim or turn off the screen, or inadvertently lock the device. In the former case, the system may inadvertently unlock the device. FIG. 6C illustrates an example workflow 600 for a quick dim process (e.g., due to the absence of a user) as part of a lock on leave evaluation. At block 602, the present state of the screen may be stored in a state controller that may be part of module controller 236 of the human presence sensor 228 of FIG. 2. The present state may be updated by an HPS service signal according to results generated by dedicated processing module 232.

Based on evaluating whether the screen is currently dimmed or not at block 604, either a dimming process 606 or an undimming process 608 will start. Assuming the current state evaluated at block 604 is that the screen is not dimmed, the process proceeds to block 606. Here, an evaluation is made at block 610 as to whether a duration since a last user action is greater than a first threshold. This threshold may correspond to a time in which screen dimming is imminent. If the duration does not exceed the first threshold, then the process proceeds to block 612. Here, if the duration since the last user action exceeds a second threshold, then the process proceeds to block 614 where dimming commences. Similarly, at block 610 when the duration exceeds the first threshold, the process also proceeds to block 614 so that the dimming can commence. This dimming can be due to inactivity, and may involve the screen gradually dimming over several seconds or more, or immediately dimming or completely turning off. If the duration does not exceed the second threshold, then the process will timeout at block 616. The system can then subsequently re-evaluate the present state starting at block 602.

When the present state is that the screen is currently dimmed, then undimming may occur under different conditions. For instance, in this scenario the undimming process within block 608 involves first evaluating whether there has been any recent user activity at block 618. If user activity has been detected, then at block 620 the screen is undimmed. However, if no user activity has been detected, then at block 622 the system evaluates whether the duration since the last detected activity is less than a third threshold. By way of example, this threshold may be on the order of several minutes or longer, e.g., at least 3-6 minutes. Here, if the duration is less, then the screen may be undimmed at block 624 by the HPS module. If the duration is greater, then the process times out at block 616 and the evaluation can begin again at present state block 602.

The system may implement quick dimming with quick locking. For instance, if a user has stopped typing, a first timer may begin (for screen locking). Here, should the presence sensor detect that the user has moved away from the computing device, a second timer (for quick dimming) may also begin. Then after the quick dimming timer exceeds its threshold (e.g., 5-30 seconds), then the screen would dim because of the user’s absence. And then when the other timer of user inactivity exceeds its threshold (e.g., 3-10 minutes), the screen would be locked. In an alternative example, after the quick dimming process has occurred because the user’s presence has not been detected according to the second timer, but before the screen becomes locked, the presence sensor detects that the user has returned. Here, so long as the first timer threshold has not been exceeded, the screen would undim (e.g., according to block 624).

An alternative or complementary option to the quick dim process is delayed dimming based on user presence. For instance, if the duration since the last detected user presence is greater than the threshold for a quick dim (e.g., on the order of 5-20 seconds), then a quick dim process can occur. However, if the user is present all the time, but there has been no relevant activity (e.g., the user is not interacting with the computing device), then eventually a standard dim process can happen. In one example, the threshold for such a process may be on the order of 10-20 minutes, or more or less.

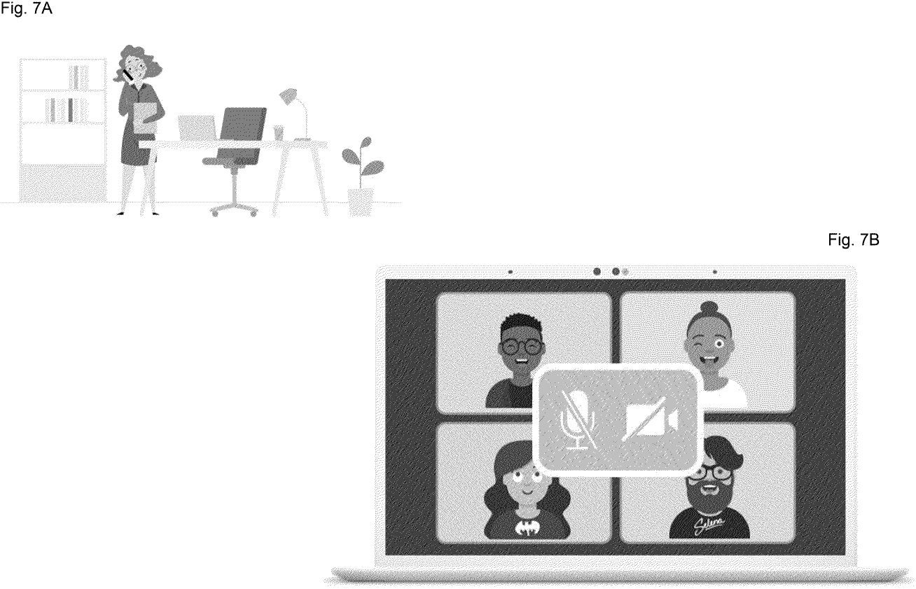

“Mute on leave” is yet another scenario. For instance, during a video call or gaming session, when no presence detected the (lack of) presence signal would cause the operating system, app or other element of the client device to mute the microphone and turn off the webcam (while the image sensor of the presence module remains active). FIG. 7A illustrates where the user steps away from the client device and FIG. 7B illustrates muting the microphone and turning off the webcam while a videoconferencing app is still active. By way of example, the microphone may be muted and the webcam turned off immediately after no presence is detected or after some limited time (e.g., 1-30 seconds). This functionality may occur before or otherwise in conjunction with a lock on leave action.

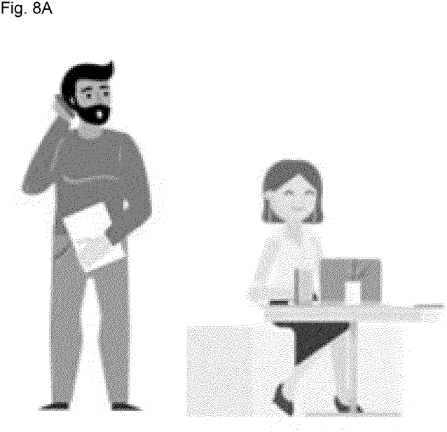

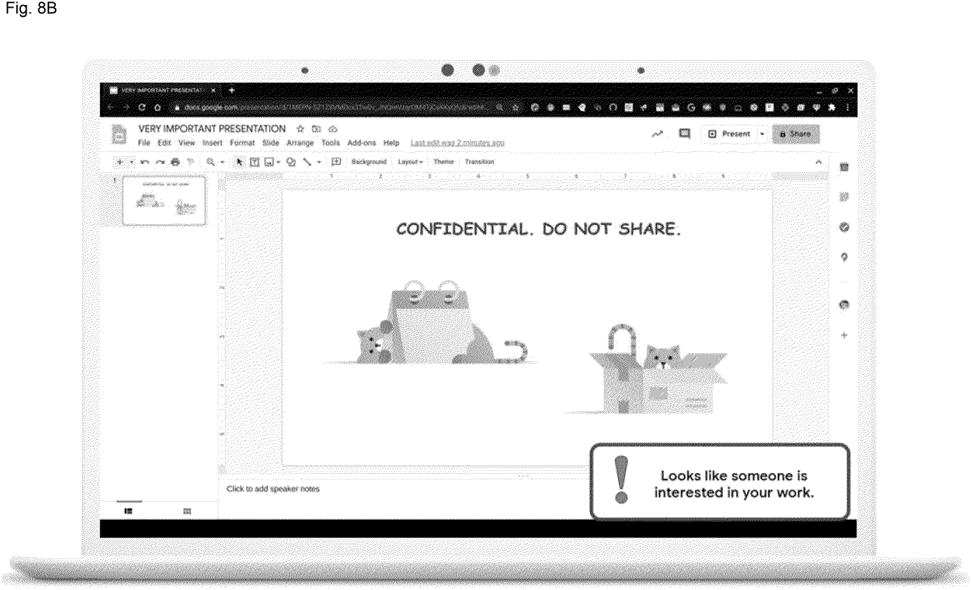

FIGS. 8A-B illustrate a “shoulder-surf” situation, in which the system notifies the user of the client device when another person is detected. Here, this may involve an unexpected face directed at the display screen. In one particular embodiment, the human presence sensor module detects that there are two faces directed at the screen. Here, recognition of the faces themselves would not be performed. However, in another embodiment an interrupt or other signal may be passed to the device’s operating system in order to authenticate the user, e.g., according to a facial recognition process. As illustrated in FIG. 8A the user may be working on confidential information when a curious onlooker takes an interest in the work. Based on the second face detection signal from the presence module, as illustrated in FIG. 8B a notification is displayed in this example that tells the user their work may be being viewed (e.g., “Looks like someone is interested in your work.”). In other examples, the system may notify the user by inserting an icon into the status bar, which symbolizes someone else is looking at the screen. A ripple or other animation may be shown around the shelf icon or other part of the GUI to catch the attention of the user. When in full screen mode or if the shelf is auto-hidden or otherwise not visible, the GUI may raise the shelf for 3 seconds (or more or less) as a notification about the other person appears. Or the GUI may show a background notification explaining the detection and presenting a button to trigger a dim screen action and/or and a button that will take user to settings for human presence sensing.

In an alternative, the system may dim the screen or block certain notifications or other information when others are looking at the screen. For instance, the contents of email messages, instant messages, calendar events, chat boxes, video or still images, audio and/or other information may be hidden or otherwise masked. This masking may be accompanied by a corresponding notification. Here, the user may be given the option of approving or rejecting the masking. In one scenario, the baseline action taken when a second person is detected can be minimal, e.g., just an icon notifying the user in conjunction with masking the user’s private notifications. The system may provide different options that the user can choose between, such as 1) just getting a small icon notification in the settings bar, 2) masking all app notifications (not including system ones a low battery warning or application crash notification), and 3) dimming the screen, which may be considered the most invasive intervention of these three options.

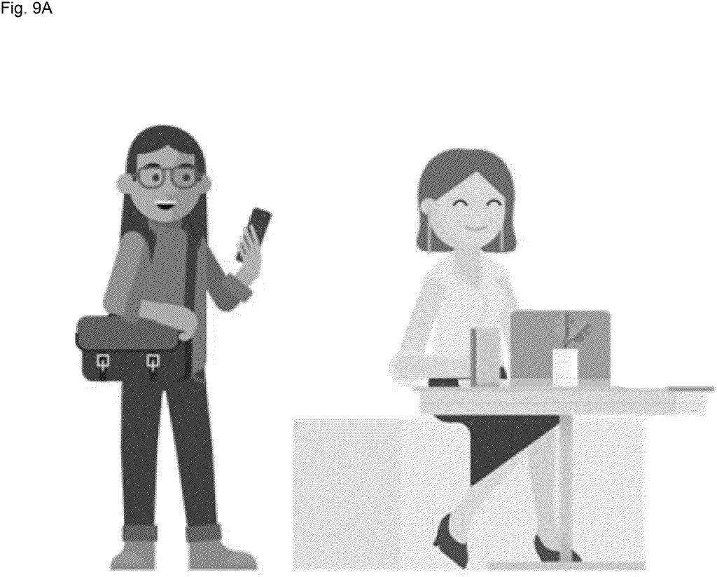

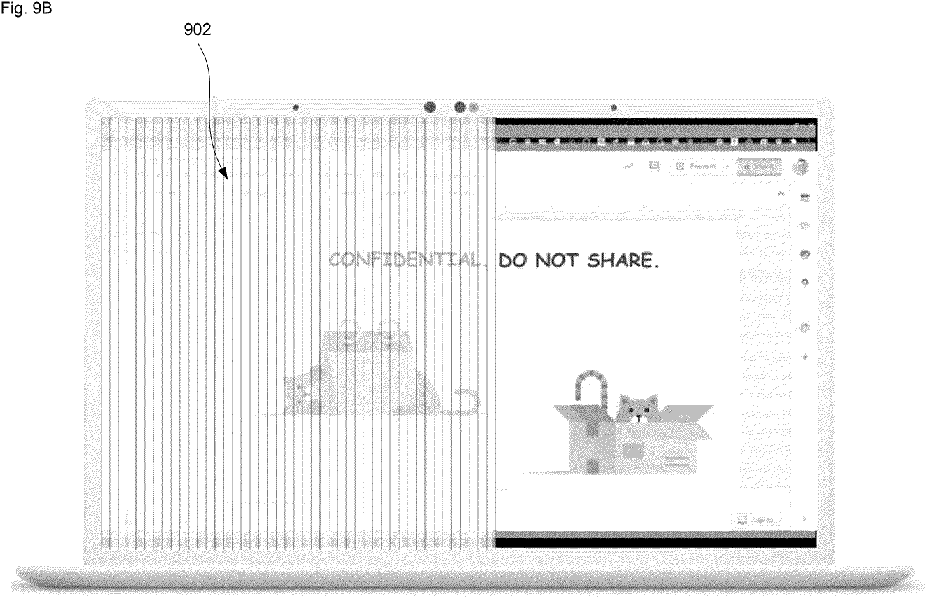

FIGS. 9A-B illustrate another scenario involving an auto-enable privacy filter. The privacy filter may be applied either when a camera is detected or multiple people are detected. For instance, as shown in FIG. 9A, a passerby may decide to take a photo of the coffee shop that the user is working in. Here, upon detection and the corresponding signal, the system may automatically apply a privacy filter on some or all of the screen. The privacy filter may include any visual changes that would make it harder to read the screen if the person is not directly in front of it. In FIG. 9B, a privacy filter 902 is shown applied to the left half of the display. In this situation, an ML model could be employed to identify different types of cameras or mobile devices that likely have cameras (e.g., mobile phones, tablets, head-mounted wearable computers, etc.)

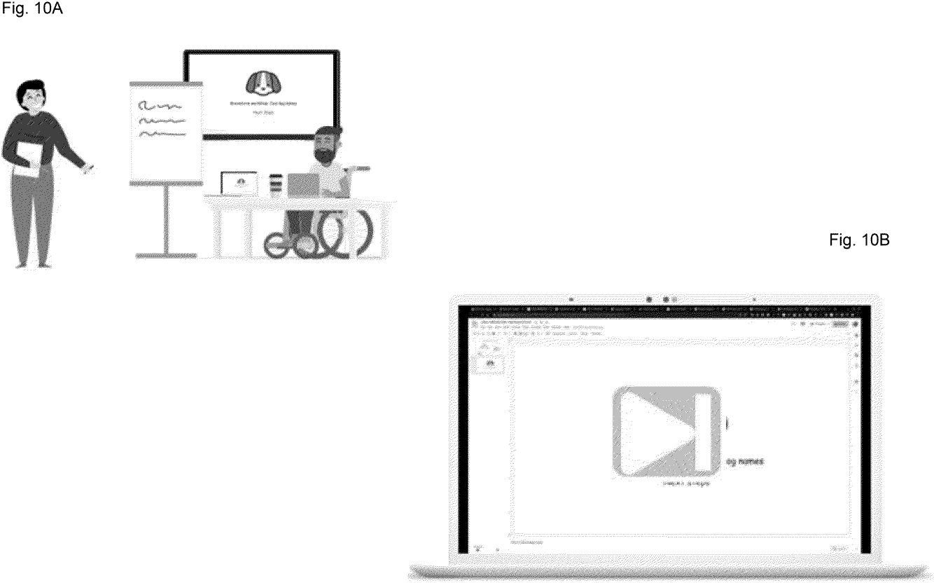

FIGS. 10A-B illustrate a situation involving a “next slide gesture”. Here, as shown in FIG. 10A, the user can wave their hand in a particular direction (e.g., left to right or right to left) in order to have a presentation proceed to a next slide or go back a slide, scroll through a document, webpage, window, tab, workspace or e-book, etc. Another gesture use case involves control for audio content, as shown in FIG. 10B. For instance, when music is playing via an app, the user can use gestures to start and pause a song, skip to the next song, or restart a song. When listening to a podcast or talk on a specific topic a gesture can be used to fast forward or rewind such as skipping forward or backward by, e.g., 10, 20 or 30 seconds at a time, move to the next segment, etc. Gesturing can also be used to turn the volume up or down. Similarly, gestures can be used for video control. Here, the user can gesture to start or pause a video, rewind or fast forward, change the volume and/or adjust the video in some way (e.g., change the brightness level or the aspect ratio). The user may gesture to control the microphone to mute it or unmute it, which can avoid the necessity of using a mouse, touch screen or physical key on the client device. When using a dictation app, gesturing can be employed to cause the app to start or stop transcribing what the person says. Similarly, the system can be used to turn sign language into subtitles or text captions in an app or other program, or to otherwise use sign language as input to control operation of an app or a component of the computing system. In a videoconference or other interactive situation, a gesture such as raising a hand can be used to notify other participants that the user has something to contribute (even when they cannot see each other). In a further situation, the user may gesture to swipe away a notification presented on the client device, or even open or otherwise act on the notification. Pinch and zoom gestures can be used to zoom in or out for displayed content and/or to maximize/minimize windows. Gestures may also be supported for swipes between virtual desks/tabs in the UI. In one scenario, the system may support customizable gestures that enable users to set certain gestures to trigger existing shortcuts, e.g., those most common to their specific needs.

In any of these types of situations, based on the type of app running (e.g., a presentation, streaming service or videoconference), the image capture rate of the image sensor of the human presence sensor module may be adjusted. Alternatively or additionally, other on-device sensors (e.g., an RF gesture detector, an acoustic sensor or the webcam or other camera of the client device) could be used for gesture interaction.

In yet another situation, the system may support “Prime face authentication”. Here, when user presence is detected and authentication is enabled, if the device is asleep, when user presence is detected and face authentication is enabled, the presence sensor module may send an interrupt or other signal so that a process associated with the operating system can begin attempting to authenticate the user, such as via facial recognition. Pairing presence sensing and recognition in a wake on approach process can result in no-touch login by the user.

A further aspect involves gaze tracking, in which the system knows where a user is looking (e.g., at a webcam, somewhere on the display screen, off screen, right/left of screen, behind the screen or looking past the client device entirely, etc.). In one aspect, this can support a suite of assistive reading feature, such as increasing the font size of text while reading, surface predictive definitions for words the user spends a long time looking at (e.g., when the user’s gaze lingers on a word or phrase for at least X seconds, such as 3-5 seconds or more), providing a visual cue such as a line reader or highlighting that moves with the user’s eyes to help them focus, automatic scrolling when reading a long document, and/or automatically masking or otherwise deemphasizing a finished part of a document or other material to reduce distraction. When the client device has multiple displays, gaze tracking can be used to present selected content on the display that the user is currently viewing. This can include presenting notifications, a launcher (e.g., when a search key is pressed), any shortcut-initiated windows, etc. This is beneficial to avoid the user having to swivel their head from one display to another. Similarly, the system can detect where the user’s attention is focused, which may or may not be towards a display. Here, the system may blur the display when the user is looking away to protect privacy. Detecting when the user is not paying attention to one or more screens enables the system to throttling the frame rate to the display modules of those screens to preserve power. Here, in one example, the system may throttle content which is deemed “uninteresting” because the user has not looked at it for a certain period of time (e.g., at least 15-20 seconds or more), e.g., by dropping animation framerate, restricting CPU clock frequencies, using only certain processing cores, etc. Alternatively or additionally, the system may nudge the user to focus if it detects that the user’s attention is divided (e.g., the user keeps glancing at their mobile phone instead of looking at the display(s) of the computing system).

The system can nudge the user to focus if it detects that the user’s attention has been diverted (e.g., if they were looking at the screen while using an app, but have glanced away for more than 15-30 seconds while still seated in front of the client device). With regard to the user’s attention, the system can estimate the strength of the attention in order to deliver important or prioritized messages when the user’s attention is determined to exceed a threshold (e.g., it is estimated with 90% confidence that the user is focused on the display, so present a notification at that time about an urgent message). The attention can be used to support apps with particular use cases, such as taking a photo for a driver’s license application or to use as an avatar for an app. Furthermore, gaze detection can be a useful input feature for certain features, such as palm rejection (e.g., when the user’s palm inadvertently rests on a trackpad of the client device), smart dimming, touchpad autocorrection, etc. In addition, combinations of gesturing and gaze detection can enhance system operation. By way of example, if the user is motor impaired, has dirty hands or otherwise cannot touch the screen (e.g., healthcare workers), the system can have a mode that uses both gaze tracking and a gesture to control the computing device.

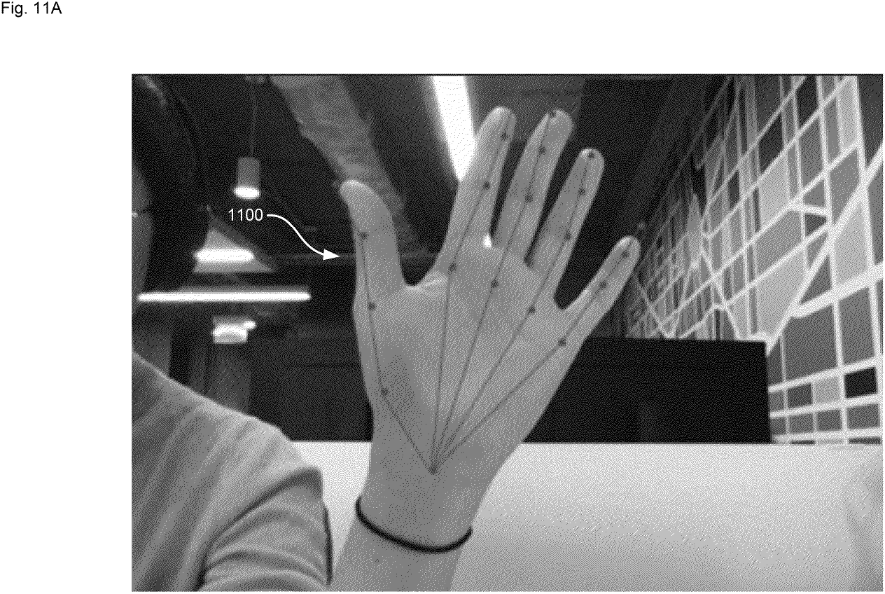

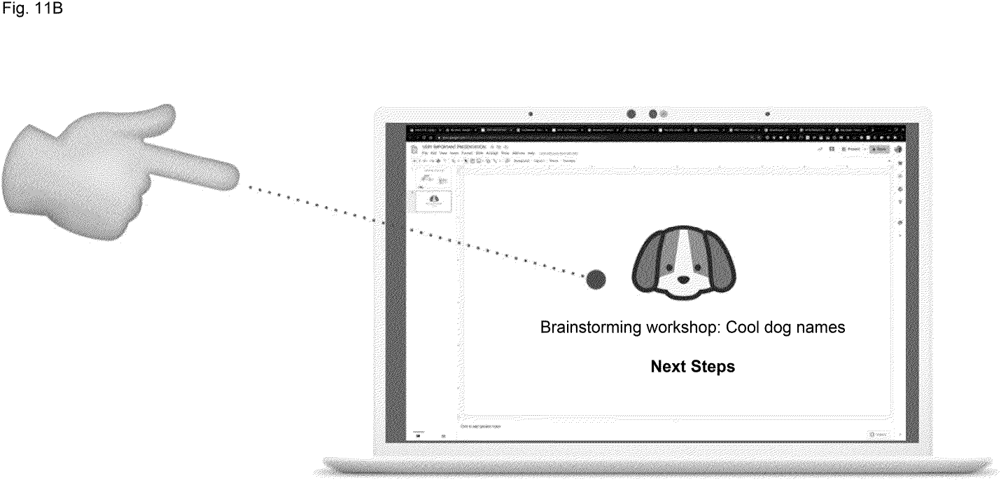

FIG. 11A illustrates a situation where the system is able to detect the user’s hand pose. Using an ML model, the system may track specific parts of the hand as shown by points 1100. This may be employed, by way of example, in pointing extrapolation as shown in FIG. 11B. For instance, when a user points at their screen, the presence sensor can detect their hand/finger (or pen, stylus, etc.) and interpolate where the user is pointing on the display. Based on this information, the OS or app can then highlight or illustrate (e.g., via a “laser-point” line with a dot) the object on the display being pointed at. Thus, this can provide a virtual pointer when the user is presenting, or when the user is commenting on a slide, doc or other material during an interaction with other (remote) participants. Alternatively or additionally, gaze detection may be employed to move a pointer on the screen to whatever display the user is looking at.

As noted above, the presence detector is configured to identify whether a person is there. In one example this can include identifying cats, dogs or other household pets (or even children), for instance using one or more specific ML models. Upon this type of detection, the system may cause keyboard or mouse/trackpad inputs to be disabled. However, other functionality such as playing an audio book or showing a video/movie on the client device may continue to be enabled.

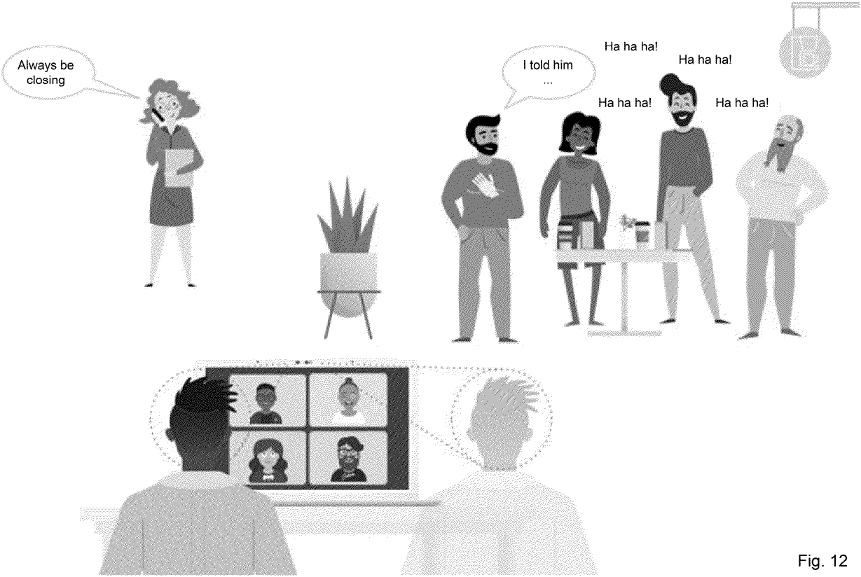

An example of dynamic beamforming is shown in FIG. 12. In one aspect, beamforming allows for background noise to be cancelled out when on a call by focusing an area of microphone input to a specific location. Using information from the human presence sensor module, the client device can identify when someone moves in its vicinity and dynamically update where the beam is directed so they will not have disruption in their talking. For instance, the human presence sensor module would determine the angle and distance to the user. This can involve detecting face location and face size in the image. Here, having one or more additional image sensors can be used to provide a stereo image for more robust pose determination of the user relative to the client device. An array or other set of microphones can use this positional information to perform spatial filtering, such as to suppress unwanted background noises.

Another scenario involves presenting notifications to others in active apps. For instance, on calls (e.g., audio calls, or video-muted calls), if a person steps away from the client device based on presence detection, that information may be used to trigger a response in the app, such as an indication to the video call service so participants in a large meeting can know not to ask the person questions. This can be particularly useful in enterprise or educational settings, especially if teachers or professors want to know their students are present in low-bandwidth settings where video may be turned off. This feature may be enabled as a user privacy selection in the operating system or a feature in the app itself, such as when the user joins a videoconference.

The presence information may be employed to turn the user interface (including a screen saver) into a useful “surface”, such as by providing health and wellness suggestions. Here, one aspect is to detect a person in the room and then turn the screen into a useful screen saver. Another aspect is to support eye strain and wellness features upon detection that a person has been at their computer for a long time. For instance, the user interface may present a reminder for the user to focus their eyes away from display at timed intervals, blink a few times, close their eyes or perform other actions to rest their eyes. Here, the system may dim the screen when the user is resting their eyes, or refrain from dimming the screen so long as the person is present in front of the device and is engaged with it. This can be associated with gaze detection as discussed above, since the system can determine where the user’s eyes are focused (and how long they have been focused during a particular task). A reminder may be provided for the user to stand up and stretch or walk away from the computer for a minute or two. Other reminders could involve posture information (“don’t hunch your shoulders”) or something else to cause a brief break in the routine (“Smile!”).

Another scenario involves “3D windows”, in which the user interface can adapt to positional (e.g., X/Y/Z) coordinates based on where/how the user is situated relative to the client device. Such information may be passed through to games for vision orientation. Besides the image sensor, other sensors of the client device could be employed (e.g., close range radar sensor, acoustical sensors, webcam, etc.).

In a further scenario, presence detection information is used to trigger bandwidth management. Thus, if a user is watching a video or using a streaming service that can consume a lot of bandwidth (and which may have a monthly data cost associated with it), the system can automatically reduce quality while the user is away and switch back to a default quality when one or more users are present. Alternatively, the video or streaming service may be paused while the user’s presence is not detected.

Other scenarios involve contextual power states. For instance, in one example a user could be sitting at their desk paying bills or other activities, and not directly interacting with the client device, but that does not mean the user wants the device to go to sleep. Here, based on the presence detection information, the system would detect that the user is still present and prevent the screensaver from starting or having the device enter a sleep mode. This avoids the user needing to move a cursor to keep the device awake.

Display brightness can rapidly degrade battery life. In another example, when the user steps away from the client device, the display can be dimmed to a minimum level and restored to the previous state once the user approaches. This could also be applied to other services running in the background that could impact battery life.

In yet another example, the system can use gaze tracking to save battery life by selectively dimming certain display areas. By way of example, when there is a single user, gaze tracking can be employed to dim areas of the display screen(s) peripheral to the gaze direction.

Another beneficial scenario for presence detection involves dynamic volume control. Here, the volume during a call or while on a game could increase or decrease depending on how far the user steps away from the client device. Distance estimation may be performed by the local processing, with or without supplemental information from other onboard sensors (e.g., acoustic or close-in radar sensors or imagery from a webcam to help provide a depth of field. The size of the person may affect the distance estimation, so information from prior detections, such as when the user is sitting in front of the device, can be employed to estimate how far they have moved from it.

In addition, low vision users often physically move their body to see the screen (e.g., hold a tablet up to their face). This can cause eye, neck, and/or back pain. Detecting when a face is really close to the screen can result in surfacing a nudge to alert the user how to use magnification, font resizing or other features to make the display more easily readable without holding it too close.

In still a further scenario, the presence detection can be used to let a logged in user know if anyone attempted to touch their computer while they were away from it. Here, the system may take a picture or video whenever someone approaches the computer, temporarily store it in local memory, and then use it to notify the authorized user. In some instances, such imagery may be shown on the display screen. The imagery may be stored in an encrypted format. In other instances, the imagery may be transmitted (e.g., via email) to the user or the user may be notified via a text message, phone call, chat or other instant message. In the situation where the imagery is sent off-device, this may only occur upon authorization of the user, with or without encryption of the transmitted imagery.

Presence sensing can be very beneficial for accessibility (e.g., “ally”) features. For instance, when a user is detected but no interaction has taken place, especially when the lock screen is presented or the machine is first out of the box, the presence information may trigger the system to enable various ally features to see if they unblock the user. By way of example, the UI may display and/or provide audio stating “We noticed you are trying to set up the computer, do you want to turn on voice control?”.

Similarly, the system could enable voice control features to aid users with motor impairments to completely control their device with voice. While sometimes it can be a challenge to always have the computer listening in that the user may have to toggle the feature off if they want to talk to someone else in the room. But using the presence sensor technology, the operating system or specific apps can stop listening to commands whenever the user turns away from the client device.

As another accessibility enhancement, visually impaired users may need to use the camera to take a selfie or join a meeting. Presence sensing information can provide hints to let users know if they’re centered within the image frame or not, if they are facing front or to the side, have their head tilted, etc. Audible, visual and/or haptic feedback can guide the person to properly align themselves in the frame. Furthermore, the presence detection information can be used by the system to select (or not select) certain authentication or verification inputs. By way of example, the system may not show a captcha if no one is present.

### User Experience

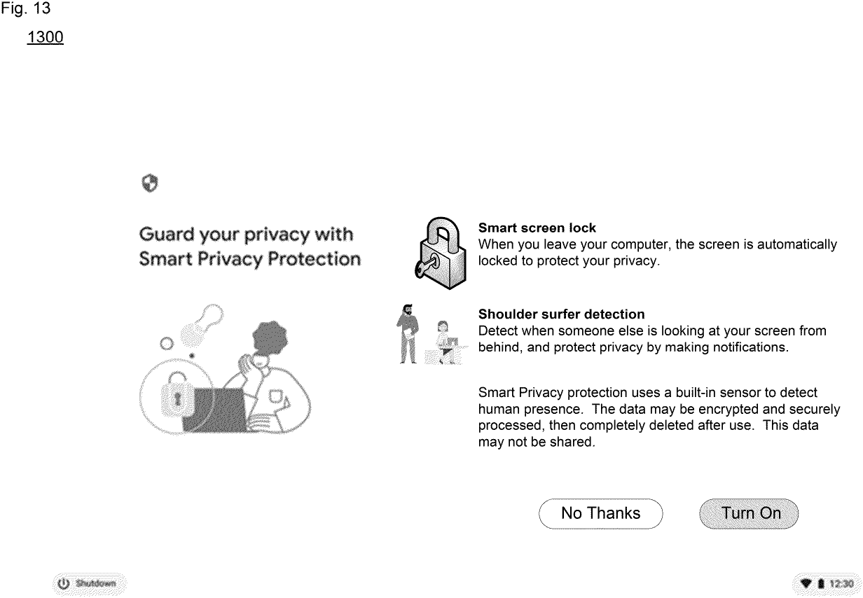

According to these embodiments, the presence detection technology may require user authorization before presence detection is enabled. This may include providing information about the technology, including how imagery may be used or stored, and enabling it upon receipt of authorization. FIG. 13 illustrates one example of information that may be presented to the user prior to enabling presence detection. And as noted above, there may be no indicator associated with the imaging device (which would otherwise always be on as the presence sensor operates). However, an icon or other indicator may be provided in a system tray, in a popup window, on the UI desktop, etc., to show the status of the presence sensing technology. In some situations, the user may elect to turn off the presence sensing technology for a particular timeframe (e.g., 5-10 minutes, an hour, all day), when using a particular app or other program (e.g., when preparing a book report or term paper), or upon a particular condition or situation.

Further to the descriptions above, a user may be provided with controls allowing the user to make an election as to both if and when systems, programs, or features described herein may enable collection of user information (e.g., imagery), and if the user is sent content or communications from a server. In addition, certain data may be treated in one or more ways before it is stored or used, so that personally identifiable information is removed. For example, a user’s identity may be treated so that no personally identifiable information can be determined for the user. Thus, the user may have control over what information is collected about the user, how that information is used, and what information is provided to the user.

### Example Network

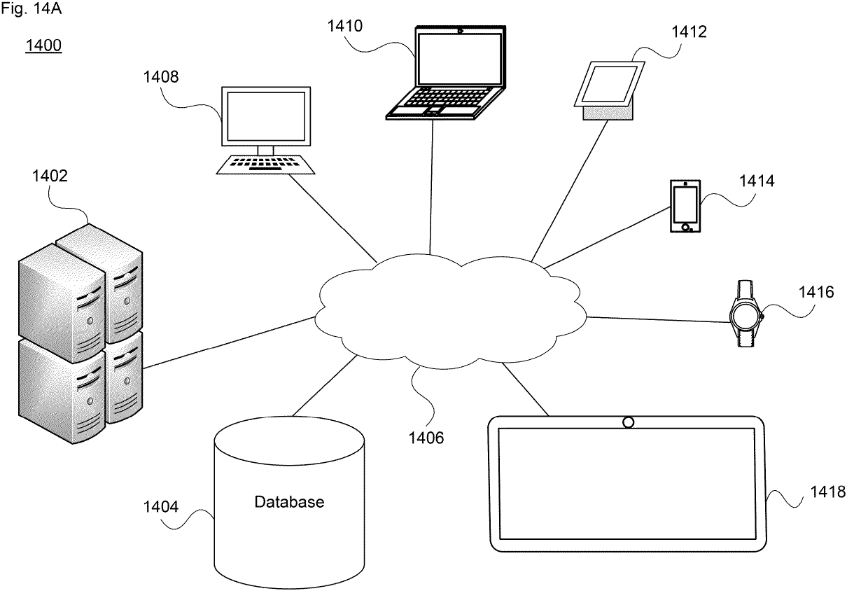

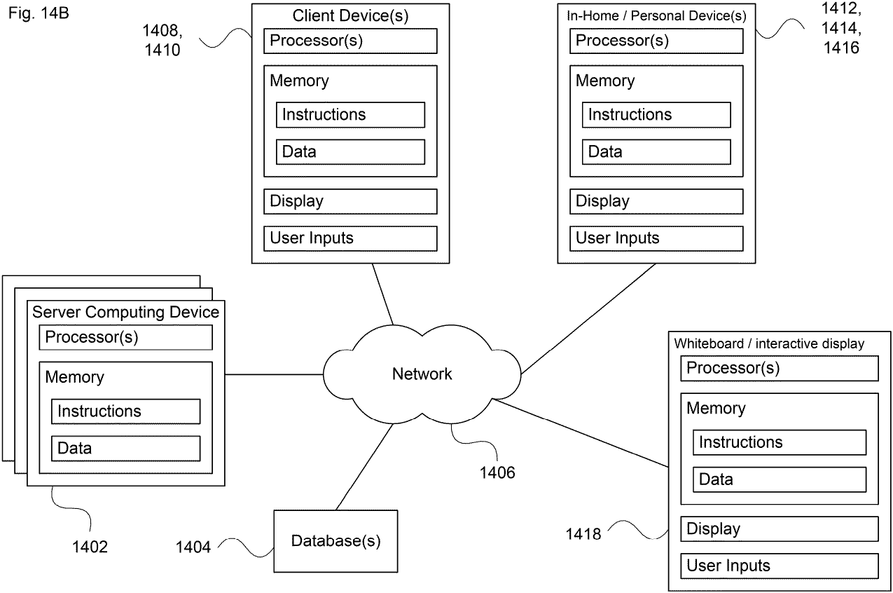

As noted above, in some situations information about whether a user is present at their client device may be communicated to others, such as those on a videoconference or interactive gaming app. How such information is generated and shared can depend on how the participants communicate with one another. One example computing architecture is shown in FIGS. 14A and 14B. In particular, FIGS. 14A and 14B are pictorial and functional diagrams, respectively, of an example system 1400 that includes a plurality of computing devices and databases connected via a network. For instance, computing device(s) 1402 may be a cloud-based server system that provides or otherwise supports one or more apps, games or other programs. Database 1404 may store app/game data, user profile information, or other information. The server system may access the databases via network 1406. Client devices may include one or more of a desktop computer 1408, a laptop or tablet PC 1410 and in-home devices such as smart display 1412. Other client devices may include a personal communication device such as a mobile phone or PDA 1414 or a wearable device 1416 such as a smartwatch, etc. Another example client device is a large screen display or interactive whiteboard 1418, such as might be used in a classroom, conference room, auditorium or other collaborative gathering space where multiple users may be present.

In one example, computing device 1402 may include one or more server computing devices having a plurality of computing devices, e.g., a load balanced server farm or cloud computing system, that exchange information with different nodes of a network for the purpose of receiving, processing and transmitting the data to and from other computing devices. For instance, computing device 1402 may include one or more server computing devices that are capable of communicating with any of the computing devices 1408-1418 via the network 1406. This may be done as part of hosting one or more collaborative apps (e.g., a videoconferencing program, an interactive spreadsheet app or a multiplayer game) or services (e.g., a movie streaming service or interactive game show where viewers can provide comments or other feedback).

As shown in FIG. 14B, each of the computing devices 1402 and 4108-1418 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing, whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 4B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 1402. Accordingly, references to a processor or computing device will be understood to include references to a collection of processors or computing devices or memories that may or may not operate in parallel.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touch screen and/or microphone) and one or more display devices that is operable to display information (e.g., text, imagery and/or other graphical elements). Other output devices, such as speaker(s) may also provide information to users. And as explained in detail above with regard to FIGS. 2-3, each client device (e.g., any or all of 1408-1418) may include a human presence sensor module in addition to the above-described elements.

The user-related computing devices (e.g., 1408-1418) may communicate with a back-end computing system (e.g., server 1402) via one or more networks, such as network 1406. The user-related computing devices may also communicate with one another without also communicating with a back-end computing system. The network 1406, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

### Exemplary Method of Operation

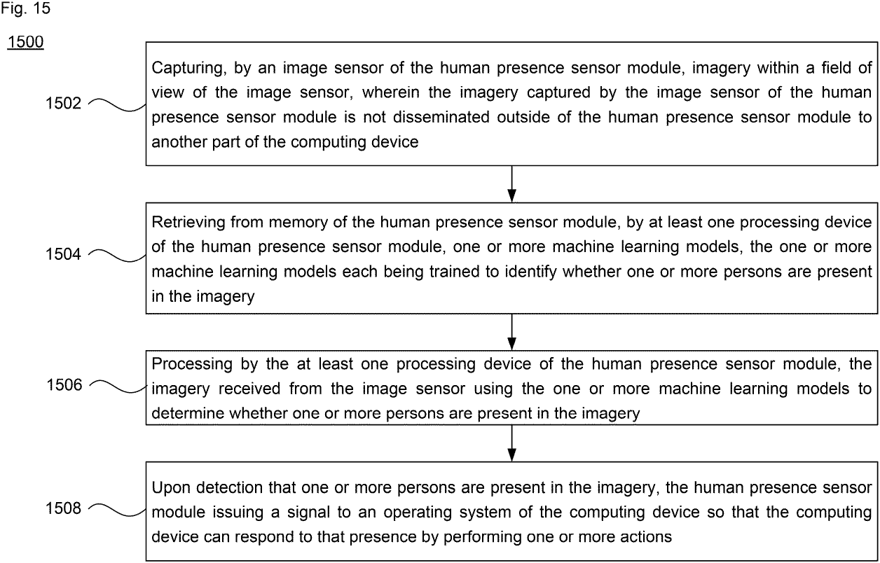

FIG. 15 illustrates a method 1500 for a computing device having a human presence sensor module in accordance with aspects of the technology. At block 1502, the method includes capturing, by an image sensor of the human presence sensor module, imagery within a field of view of the image sensor. According to one aspect of the technology, the imagery captured by the image sensor of the human presence sensor module is restricted to the human presence sensor module (e.g., for temporary storage during processing), and is not disseminated outside of the human presence sensor module to another part of the computing device. At block 1504, the method includes retrieving from memory of the human presence sensor module, by at least one processing device of the human presence sensor module, one or more machine learning models. The one or more machine learning models are each trained to identify whether one or more persons are present in the imagery. At block 1506, the method includes processing, by the at least one processing device of the human presence sensor module, the imagery received from the image sensor using the one or more machine learning models to determine whether one or more persons are present in the imagery. And at block 1508, the method includes, upon detection that one or more persons are present in the imagery, the human presence sensor module issuing a signal to an operating system of the computing device so that the computing device can respond to that presence by performing one or more actions.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computing device, comprising:
a processing module including one or more processors;
memory, communicatively coupled to the processing module, configured to store data and instructions associated with an operating system of the computing device; and
a human presence sensor module, the human presence sensor module including:
an image sensor configured to capture imagery within a field of view of the image sensor;
dedicated memory configured to store one or more machine learning models, the one or more machine learning models each being trained to identify whether one or more persons are present in the imagery; and
a dedicated processing module including at least one processing device configured to process the imagery received from the image sensor using the one or more machine learning models to determine whether one or more persons are present in the imagery; wherein:
imagery captured by the image sensor of the human presence sensor module is restricted to the human presence sensor module; and
in response to detection that one or more persons are present in the imagery, the human presence sensor module is configured to issue a signal to the processing module of the computing device, such that the computing device responds to the signal by executing one or more instructions associated with the operating system of the computing device.

2. The computing device of claim 1, wherein:
the human presence sensor module further includes a module controller operatively coupled to the image sensor, the dedicated memory and the dedicated processing module; and
the module controller is configured to receive a notification from the dedicated processing module about the presence of the one or more persons in the imagery, and to issue the signal to the processing module of the computing device.

3. The computing device of claim 2, wherein the image sensor is further configured to:
detect motion between sequential images; and
to issue a wake on approach signal to the module controller in order to enable the module controller to cause one or more components of the human presence sensor module to wake up from a low power mode.

4. The computing device of claim 2, wherein:
the image sensor is further configured to detect motion between sequential images; and
the dedicated processing module is configured to start processing the imagery in response to the detection of motion.

5. The computing device of claim 1, wherein the one or more machine learning models comprise a first machine learning model trained to detect the presence of a single person in the imagery, and a second machine learning model trained to detect the presence of at least two people in the imagery.

6. The computing device of claim 5, wherein the machine learning models further include a model to detect at least a portion of a human face, a model to detect a human torso, a model to detect a human arm, or a model to detect a human hand.

7. The computing device of claim 1, wherein the signal to the processing module of the computing device is an interrupt, and the interrupt causes a process of the computing device to wake the computing device from a suspend mode or a standby mode.

8. The computing device of claim 1, wherein the signal to the processing module of the computing device is an interrupt, and the interrupt causes a process of the computing device to initiate face authentication using imagery other than the imagery obtained by the image sensor of the human presence sensor module.

9. The computing device of claim 1, further comprising:
a display module having a display interface, the display module being communicatively coupled to the processing module, the display module being configured to present information to a user;
wherein the signal to the processing module of the computing device is an interrupt, and the interrupt causes a process of the computing device to display information on the display module.

10. A computer-implemented method for a computing device having a human presence sensor module, the method comprising:
capturing, by an image sensor of the human presence sensor module, imagery within a field of view of the image sensor, wherein the imagery captured by the image sensor of the human presence sensor module is restricted to the human presence sensor module;
retrieving from memory of the human presence sensor module, by at least one processing device of the human presence sensor module, one or more machine learning models, the one or more machine learning models each being trained to identify whether one or more persons are present in the imagery;
processing by the at least one processing device of the human presence sensor module, the imagery received from the image sensor using the one or more machine learning models to determine whether one or more persons are present in the imagery; and
upon detection that one or more persons are present in the imagery, the human presence sensor module issuing a signal to a processing module of the computing device so that the computing device can respond to that presence by performing one or more actions.

11. The method of claim 10, further comprising, in response to detection of the presence of the one or more persons, causing the computing device to wake on arrival of a person within the field of view of the image sensor.

12. The method of claim 10, further comprising, in response to detection of a person leaving the field of view of the image sensor, causing the computing device to lock so that authentication is required to access one or more programs of the computing device.

13. The method of claim 10, further comprising, in response to detection of a person leaving the field of view of the image sensor, at least one of muting a microphone of the computing device or turning off a camera of the computing device, wherein the camera is not the image sensor of the human presence sensor module.

14. The method of claim 10, further comprising, in response to detection of the presence of at least two persons in the imagery, performing at least one of issuing a notification to a user of the computing device or blocking one or more notifications from being presented to the user.

15. The method of claim 10, further comprising, in response to detection of the presence of at least two persons in the imagery, enabling a privacy filter on a display of the computing device.

16. The method of claim 10, further comprising, in response to detection of the presence of one person in the imagery, performing gesture detection based on additional imagery captured by the image sensor of the human presence sensor module.

17. The method of claim 10, further comprising, in response to detection of the presence of one person in the imagery, performing gaze tracking based on additional imagery captured by the image sensor of the human presence sensor module.

18. The method of claim 10, further comprising, in response to detection of the presence of one person in the imagery, performing dynamic beamforming to cancel background noise based on additional imagery captured by the image sensor of the human presence sensor module.

19. The method of claim 10, further comprising:
detecting, by the image sensor, motion between sequential images of the captured imagery; and
causing one or more components of the human presence sensor module to wake up from a low power mode in response to detecting the motion.

20. The method of claim 10, wherein the signal to the processing module of the computing device is an interrupt, and the interrupt causes a process of the computing device to initiate face authentication using imagery other than the imagery obtained by the image sensor of the human presence sensor module.
